(19) United States
(12) Patent Application Publication
(10) Pub. No.: US 2009/0253456 A1
(43) Pub. Date: Oct. 8, 2009

(54) DUAL BAND RECEIVER WITH CONTROL MEANS FOR PREVENTING SIGNAL OVERLOADING

(75) Inventors: Yeow Teng Toh, Singapore (SG); Kam Choon Kwong, Singapore (SG)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,166

(22) PCT Filed: Jun. 12, 2007
(86) PCT No.: PCT/IB2007/052223

§ 371 Date: Dec. 22, 2008

(30) Foreign Application Priority Data
Jun. 22, 2006 (EP) 06115911.7

(51) Int. Cl. H04B 7/00; H04M 1/00; H04B 1/06

(52) U.S. Cl. 455/550.1; 455/277.2; 455/232.1

(57) ABSTRACT

A portable dual band receiver (D), intended for equipping a mobile equipment, comprises a first antenna (AN1), a second antenna (AN2), a two-states switching means (SW) connected to the first (AN1) and second (AN2) antennas and arranged to deliver either first signals comprised into a first band when it is set into a first state or second signals comprised into a second band when it is set into a second state, at least one low noise amplifier (A1, A2) arranged to amplify the signals delivered by the switching means (SW), a processing means (PM) arranged to process the signals outputted by the low noise amplifier(s) (A1,A2) either in a first mode or in a second mode, and a control means (CM) arranged, when the processing means (PM) works in the second mode, to determine which of the first (AN1) and second (AN2) antennas induces the best reception quality into the processing means (PM), and to set the switching means (SW) in the state which allows it to deliver the signals received by the antenna that it has determined.

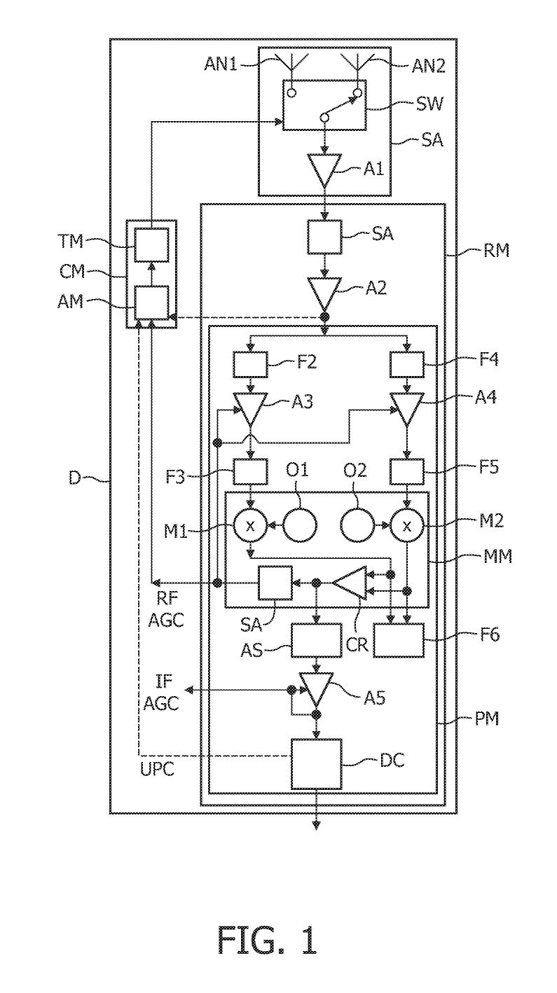

The present invention relates to dual band receivers adapted to receive analog and/or digital television (TV) signals into an equipment, possibly of the mobile or portable type, such as a mobile telephone, a laptop, a personal digital assistant, a portable media player or a television set equipping a vehicle, for instance.

A dual band TV receiver (for instance a VHF/UHF one) comprises usually a dual band (VHF/UHF) switchable antenna and a receiver module connected to the output of the dual band (VHF/UHF) switchable antenna to be fed either with first (VHF) signals when it works in a first (VHF) mode or with second (UHF) signals when it works in a second (UHF) mode. The dual band (VHF/UHF) switchable antenna comprises usually a switching module followed by a first low noise amplifier (LNA), and the receiver module comprises usually a second low noise amplifier (LNA) located after an input (high-pass) filter connected to the output of the first low noise amplifier. So, the received signals have to go through two cascaded low noise amplifiers before being processed in a first (VHF) or second (UHF) mode.

With such an arrangement, when the portable dual band receiver is near a radiofrequency (RF) power transmitter it receives too much signal, which induces an overload of its cascaded low noise amplifiers and therefore does not allow its receiver module to receive the TV signals properly.

To overcome such a drawback, it would be possible to use only one input low noise amplifier instead of two cascaded ones. But, when the portable dual band receiver comprises only one input low noise amplifier it fails to receive signals at a distance of a RF power transmitter which is smaller than the one at which a portable dual band receiver comprising two cascaded input low noise amplifiers fails to receive signals.

So, the object of this invention is to improve the situation.

For this purpose, it provides a dual band receiver, intended for equipping an equipment, and comprising a first antenna, a second antenna, a two-states switching means connected to the first and second antennas and arranged to deliver either first signals comprised into a first band when it is set into a first state or second signals comprised into a second band when it is set into a second state, at least one low noise amplifier arranged to amplify the signals delivered by the switching means, and a processing means arranged to process the signals outputted by the low noise amplifier(s) either in a first mode or in a second mode.

By definition, the first antenna introduces a greater signal attenuation than the second one. For instance, the first antenna is a VHF antenna, the first mode is a VHF mode and the first signals are VHF signals, while the second antenna is an UHF antenna, the second mode is an UHF mode and the second signals are UHF signals. In this case, the VHF antenna introduces a greater signal attenuation than the UHF antenna.

This dual band receiver is characterized in that it also comprises a control means arranged, when the processing means works in the second mode, to determine which of the first and second antennas induces the best reception quality into the processing means, and to set the switching means in the state which allows it to deliver the signals received by the antenna that it has just determined.

In a first embodiment, the control means may comprise a triggering means arranged to set the state of the switching means, and an analysis means arranged, when the processing means works in the second mode, i) to order to the triggering means to set the switching means in its first (or second) state in order to determine at least a first parameter value representative of the amplitude of the signals outputted by said low noise amplifier(s) consecutively to the setting in this first state, then ii) to order to the triggering means to set the switching means in its second (or first) state in order to determine at least a second parameter value representative of the amplitude of the signals outputted by said low noise amplifier(s) consecutively to the setting in this second state, then iii) to compare the first parameter value with the second parameter value in order to determine the smallest one, and then iv) to order to the triggering means to set the switching means in the state which induces the smallest of the first and second parameter values. For instance, the parameter values are the amplitudes of the signals outputted by the low noise amplifier(s).

In a second embodiment, the processing means may comprise at least one calculation means arranged to compute at least a parameter value representative of the reception quality, and the control means may comprise a triggering means arranged to set the state of the switching means, and an analysis means arranged, when the processing means receives second signals and works in the second mode, i) to determine at least the current parameter value computed by the calculation means, then ii) to compare this current parameter value with a chosen threshold, and iii) to order to the triggering means to set the switching means in its first state when the current parameter value is smaller than the threshold. For instance, the calculation means may be a radiofrequency automatic gain controller arranged to compute a gain control value defining the parameter value and intended to be used by the processing means.

In a third embodiment, the processing means may comprise at least one first calculation means arranged to compute at least a primary parameter value representative of the reception quality, and the control means may comprise a triggering means arranged to set the state of the switching means and an analysis means arranged, when the processing means works in the second mode, i) to order to the triggering means to set the switching means in its first state in order to determine at least a first primary parameter value computed by the first calculation means and a first secondary parameter value also representative of the reception quality, consecutively to the setting in the first state, then ii) to order to the triggering means to set the switching means in its second state in order to determine at least a second primary parameter value computed by the calculation means and a second secondary parameter value also representative of the reception quality, consecutively to the setting in the second state, and then iii) either to stop to intervene if the second secondary parameter value is equal to a chosen value (for instance zero) or, if this second secondary parameter value is different from the chosen value, to compare the second primary parameter value with a chosen threshold and either to stop to intervene if the second primary parameter value is greater than the threshold, or to order to the triggering means to set the switching means in its first state if the second primary parameter value is smaller than the threshold and if the first secondary parameter value is equal to the chosen value.

In this third embodiment, the first calculation means may be, for instance, a radiofrequency (RF) automatic gain controller arranged to compute a gain control value defining the primary parameter value and intended to be used by the processing means. Moreover, the secondary parameter value may be, for instance, a value of a parameter called “Uncorrectable Packet Count” (UPC).

The invention also provides an equipment, possibly of the mobile or portable type, comprising a dual band receiver such as the one above introduced. Such an equipment may be a mobile telephone, a laptop, a personal digital assistant, a portable media player or a television set equipping a vehicle, for instance.

Other features and advantages of the invention will become apparent on examining the detailed specifications hereafter and the appended drawing, wherein the unique figure schematically illustrates an example of dual band receiver according to the invention. The appended drawing may not only serve to complete the invention, but also to contribute to its definition, if need be.

The invention aims at offering a dual band receiver capable of properly receiving TV signals even when it is located near a RF power transmitter.

In the following description it will be considered that the dual band receiver is intended for a mobile or portable equipment such as a mobile telephone. But it is important to notice that the invention is not limited to this type of equipment. Indeed, it may equip any equipment, mobile or portable or not, capable of displaying television programs, and notably a laptop, a personal digital assistant, a portable media player or a television set equipping a vehicle.

Moreover, in the following description it will be considered that the first band is the VHF band while the second band is the UHF band.

As schematically illustrated in the unique figure, a dual band receiver D according to the invention comprises a VHF/UHF switchable antenna SA, a receiver module RM connected to the output of the VHF/UHF switchable antenna SA to be fed either with first (VHF) signals when it works in a first (VHF) mode or with second (UHF) signals when it works in a second (UHF) mode, and a control module CM.

It is recalled that the VHF band extends approximately between 140 MHz and 240 MHz, while the UHF band extends approximately between 400 MHz and 900 MHz.

In the example of embodiment illustrated in the unique figure, the control module CM is not a part of the receiver module RM, but in a variant it could be part of the receiver module RM.

The VHF/UHF switchable antenna SA comprises a first antenna AN1 for receiving VHF television signals transmitted by a RF power transmitter such as a base station, a second antenna AN2 for receiving UHF television signals also transmitted by the RF power transmitter, a two-states switching module SW, and a first low noise amplifier (LNA) A1.

The VHF antenna introduces a greater signal attenuation than the UHF antenna.

The switching module SW comprises two signal inputs connected respectively to the output of the first (VHF) AN1 and second (UHF) AN2 antennas, an output to deliver either VHF signals when its switching module SW is set into a first state or UHF signals when its switching module SW is set into a second state, and a control input to receive state commands, notably from the control module CM.

The first low noise amplifier A1 comprises an input connected to the output of the switching module SW and an output for delivering amplified VHF or UHF signals.

Such a VHF/UHF switchable antenna SA may be, for instance, the one which is manufactured by PHILIPS under the reference ANT2216W.

The receiver module RM comprises preferably a filter F1, a second low noise amplifier A2 and a processing module PM.

For instance the filter F1 may be a high-pass filter. It comprises an input connected to the output of the first low noise amplifier A1 and an output to deliver filtered and amplified VHF or UHF signals.

The second low noise amplifier A2 comprises an input connected to the output of the filter F1 and an output for delivering filtered and amplified VHF or UHF signals.

The processing module PM comprises an input connected to the output of the second low noise amplifier A2 and an output for delivering processed digital data representative of the TV signals received by the first AN1 or second AN2 antenna.

This processing module PM is arranged to work either in a first (VHF) mode or in a second (UHF) mode.

As illustrated in the unique figure, the processing module PM comprises for instance:
a first path connected to its input and dedicated to VHF signals. This first path comprises for instance a VHF input filter F2 followed by an amplifier A3 with an adjustable gain, followed by a band-pass filter F3,
a second path connected to its input and dedicated to UHF signals. This second path comprises for instance an UHF input filter F4 followed by an amplifier A4 with an adjustable gain, followed by a band-pass filter F4,
a module MM intended for mixing, signal conversion from radiofrequency (RF) to intermediate frequency (IF), IF filtering, IF amplification and gain control, and comprising for this purpose i) a first mixer M1 fed with the output of the first path and with a VHF reference signal delivered by a VHF oscillator O1 and outputting VHF mixed signals at an intermediate frequency (IF), ii) a second mixer M2 fed with the output of the second path and with an UHF reference signal delivered by an UHF oscillator O2 and outputting UHF mixed signals at an intermediate frequency (IF), iii) an intermediate frequency (IF) amplifier CR comprising two inputs connected to the output of the first M1 and second M2 mixers and an output for delivering output IF signals (representative of the received RF signals after amplification and conversion into intermediate frequency (IF)), and iv) a radiofrequency (RF) automatic gain controller GC connected to the output of the IF amplifier CR and arranged to determine the gain control value (RF AGC) to apply to the amplifiers A3 and A4 from the output IF signals,
an intermediate frequency (IF) filtering module F6,
a selective channel filtering module AS,
an amplifier A5 having an input connected to the output of the module MS and an output delivering amplified digital IF signals, for instance of the DVB-T type,
a digital channel decoder DC connected to the output of the amplifier A5 and arranged to decode the (DVB-T) digital IF signals into MPEG streams, for instance.
Such a receiver module RM may be, for instance, the one which is manufactured by PHILIPS under the reference PDD2016R.

This control module CM intervenes each time the processing module PM works in the UHF mode. It is arranged to determine which of the first (VHF) antenna AN1 and second (UHF) antenna AN2 induces the best reception quality into the processing module PM, in order to set the switching module SW in the state (first or second) which allows it to deliver the TV signals that are received by the antenna AN1 or AN2 that it has determined.

In other words, if the best reception quality is obtained with signals received by the first antenna AN1, then the control module CM sets the switching module SW into its first state in order it delivers the VHF signals, and if the best reception quality is obtained with signals received by the second antenna AN2, then the control module CM sets the switching module SW into its second state in order it delivers the UHF signals.

One means here by “best reception quality” the least distortion and the highest signal-to-noise ratio (SNR) for the digital IF signals outputted by the digital channel decoder DC.

The control module CM may determine the antenna to be used according to at least three different manners. Both of these three manners preferably require the use of an analysis module AM and a triggering module TM as illustrated in the unique figure.

In both of the three manners the triggering module TM is provided for sending a state command, intended for setting the state of the switching module SW, depending on the corresponding command (or instruction) received from the analysis module AM.

In the first manner, the analysis module AM intervenes each time the processing module PM works in the UHF mode. In this situation the analysis module AM sends a command (or instruction), which requires setting of the switching module SW in its first (or second) state, to the triggering module TM. In response to this command the triggering module TM generates a state command and sends it to the switching module SW.

When the switching module SW is in its first (or second) state the processing module PM processes VHF (or UHF) signals. Therefore, the signals outputted by the second low noise amplifier AN2 have a first amplitude. The analysis module AM then determines a first parameter value v1 which is representative of this first amplitude. For instance, the first parameter value v1 is the first signal amplitude at the output of the second low noise amplifier AN2 (as illustrated by the arrow in dotted line in the unique figure).

It is important to notice that the analysis module AM could also take into account one or more other (possibly additional) parameters than the signal amplitude to determine which antenna must be selected to induce the best reception quality. For instance, it may also use the signal-to-noise ratio (SNR) and/or the bit error rate (BER) and/or the Uncorrectable Packet Error (UPC) computed by the digital channel decoder DC and/or the gain control voltage (or RF AGC voltage) outputted by the RF automatic gain controller GC.

The analysis module AM stores the first parameter value v1 (here the signal amplitude) and then sends another command (or instruction), which requires setting of the switching module SW in its second (or first) state, to the triggering module TM. In response to this command the triggering module TM generates a state command and sends it to the switching module SW.

When the switching module SW is in its second (or first) state the processing module PM processes UHF (or VHF) signals. Therefore, the signals outputted by the second low noise amplifier AN2 have a second amplitude. The analysis module AM then determines a second parameter value v2 which is representative of this second amplitude. For instance, the second parameter value v2 is the second signal amplitude at the output of the second low noise amplifier AN2.

The analysis module AM stores this second parameter value v2 (here a signal amplitude) and then compares it with the first parameter v1 in order to determine the smallest one.

Then, the analysis module AM sends another command (or instruction), which requires setting of the switching module SW in the state which induces the smallest of the first v1 and second v2 parameter values, to the triggering module TM.

For instance, if v1 corresponds to VHF signals and if v1<v2, then the analysis module AM sends a command (or instruction), which requires setting of the switching module SW in its first state, to the triggering module TM, so that the processing module PM processes VHF signals while working in the UHF mode. Such a situation may occur when the dual band receiver D is near a RF power transmitter. The use of the first (VHF) antenna AN1 induces an attenuation of the signal amplitude compared to the one offered by the second (UHF) antenna AN2. Typically this attenuation is approximately equal to 15 dB. This attenuation allows to strongly decrease, even suppress, the signal overloading into the cascaded low noise amplifiers A1 and A2, and therefore to properly receive the signals in the UHF mode.

Now, if v1 corresponds to VHF signals and if v1>v2, then the analysis module AM sends a command (or instruction), which requires setting of the switching module SW in its second state, to the triggering module TM, so that the processing module PM processes UHF signals while working in the UHF mode. Such a situation may occur when the dual band receiver D is far away from a RF power transmitter. The use of the second (UHF) antenna AN2 induces an increase of the signal amplitude compared to the one offered by the first (VHF) antenna AN1. Typically this increase is approximately equal to 15 dB. This increase allows to properly receive the signals in the UHF mode.

In the second manner, the analysis module AM intervenes each time the processing module PM processes UHF signals (delivered by the second (UHF) antenna AN2) in the UHF mode. In this situation the analysis module AM stores at least one current parameter value v which has been computed by at least one calculation means from the signals outputted by the IF amplifier CR.

For instance, a calculation means is the RF automatic gain controller GC which computes gain control values defining parameter values directly representative of the reception quality. Each gain control value is a voltage which is used to adjust the gain of the amplifiers A3 and A4 of the first and second paths. When the power of the received signal is high then the gain control value is low.

It is important to notice that in this second manner the analysis module AM could also take into account one or more other (additional) parameters than the gain control value to determine which antenna must be selected to induce the best reception quality. For instance, it may also use the signal-to-noise ratio (SNR) and/or the bit error rate (BER) and/or the Uncorrectable Packet Error (UPC) computed by the digital channel decoder DC.

In case where the calculation means is the RF automatic gain controller GC, the analysis module AM compares at least the current gain control value v with a chosen threshold Td.

If the current gain control value v is smaller than the threshold Td (v<Td), this means that the power of the received signal is high. Then, the analysis module AM sends a command (or instruction) to the triggering module TM which requires setting of the switching module SW in the first state. Therefore the processing module PM processes VHF signals while working in the UHF mode. Such a situation may occur when the dual band receiver D is near a RF power transmitter. As in the first manner, the use of the first (VHF) antenna AN1 induces an attenuation of the signal amplitude compared to the one offered by the second (UHF) antenna AN2. This attenuation allows to strongly decrease, even suppress, the signal overloading into the cascaded low noise amplifiers A1 and A2, and therefore to properly receive the signals in the UHF mode.

Now, if the current gain control value v is greater than the threshold Td (v>Td), the analysis module AM does not send any command (or instruction) to the triggering module TM so that the processing module PM continues to process UHF signals while working in the UHF mode.

In the third manner (variant of the second one), the analysis module AM intervenes each time the processing module PM works in the UHF mode. In this situation the analysis module AM sends a command (or instruction), which requires setting of the switching module SW in its first (or second) state, to the triggering module TM. In response to this command the triggering module TM generates a state command and sends it to the switching module SW.

When the switching module SW is in its first (or second) state the processing module PM processes VHF (or UHF) signals. The analysis module AM stores at least one first primary parameter value v1 which has been computed by at least one first calculation means from the signals outputted by the IF amplifier CR and a first secondary parameter value u1 representative of the quality.

For instance, a first calculation means is the RF automatic gain controller GC which computes gain control values (voltages) defining primary parameter values directly representative of the reception quality.

For instance, the first secondary parameter value u1 is the Uncorrectable Packet Count (UPC) which is computed by a calculation means (here the digital channel decoder DC), as illustrated by the arrow in dotted line in the unique figure. It is recalled that as long as the UPC value remains equal to zero (0), there is no visible error on the screen which displays the images resulting from the received TV signals.

It is important to notice that the analysis module AM could also take into account one or more other (additional) parameters than the control gain to determine which antenna must be selected to induce the best reception quality. For instance, it may also use the signal-to-noise ratio (SNR) and/or the bit error rate (BER).

The analysis module AM stores the first primary parameter value v1 (here the control gain value) and the first secondary parameter value u1 (here the UPC value), and then sends another command (or instruction), which requires setting of the switching module SW in its second (or first) state, to the triggering module TM. In response to this command the triggering module TM generates a state command and sends it to the switching module SW.

When the switching module SW is in its second (or first) state the processing module PM processes UHF (or VHF) signals. Therefore, the signals outputted by the second low noise amplifier AN2 have a second amplitude. The analysis module AM then determines a second primary parameter value v2 and a second secondary parameter value u2 representative of the quality. For instance, the second primary parameter value v2 is the second control gain value determined by the RF automatic control gain GC and the second secondary parameter value u2 is the uncorrectable packet count (UPC).

The analysis module AM stores the second primary parameter value v2 (here a signal amplitude) and the second secondary parameter value u2 (here the UPC value).

If the second secondary parameter value u2 is equal to a chosen value, for instance zero (0), the analysis module AM does not send any command (or instruction) to the triggering module TM so that the processing module PM continues to process UHF signals while working in the UHF mode.

If the second secondary parameter value u2 is greater than the chosen value (here equal to zero (0)), the analysis module AM compares the second gain control value v2 with a chosen threshold Td′.

If the second gain control value v2 is greater than the threshold Td′ (v2>Td′), the analysis module AM does not send any command (or instruction) to the triggering module TM so that the processing module PM continues to process UHF signals while working in the UHF mode.

Now, if the second gain control value v2 is smaller than the threshold Td′ (v2<Td′), this means that the power of the received signal is high. Then, if the first secondary parameter value u1 is equal to the chosen value (here equal to zero (0)), the analysis module AM sends a command (or instruction) to the triggering module TM which requires setting of the switching module SW in the first state. Therefore the processing module PM processes VHF signals while working in the UHF mode. Such a situation may occur when the dual band receiver D is near a RF power transmitter. As in the first and second manners, the use of the first (VHF) antenna AN1 induces an attenuation of the signal amplitude compared to the one offered by the second (UHF) antenna AN2. This attenuation allows to strongly decrease, even suppress, the signal overloading into the cascaded low noise amplifiers A1 and A2, and therefore to properly receive the signals in the UHF mode.

The control module CM, and more precisely its analysis module AM and triggering module TM, may be (part of) an integrated circuit (for instance an ASIC) realized in any technology used in chip industry fabrication (for instance in CMOS technology). But it may be also implemented as a software, or as a combination of hardware and software modules. In any case, the control module CM may be part or not of the receiver module RM.

The invention is not limited to the embodiments of dual band receiver and equipment described above, only as examples, but it encompasses all alternative embodiments which may be considered by one skilled in the art within the scope of the claims hereafter.

Thus in the preceding description it has been described an example of embodiment of a dual band receiver comprising two cascaded low noise amplifiers. But the invention also applies to dual band receivers comprising only one low noise amplifier located either into the output part of its dual band switchable antenna or into the input part of its receiver module.

Moreover, in the preceding description it has been described an example of embodiment of a VHF/UHF receiver. But the invention applies to any dual band receiver in which the dual band switchable antenna comprises a first antenna which introduces a greater signal attenuation than the second one.

1. Dual band receiver for a mobile equipment, comprising a first antenna, a second antenna, a two-states switching means connected to said first and second antennas and arranged to deliver either first signals comprised into a first band when it is set into a first state or second signals comprised into a second band when it is set into a second state, at least one low noise amplifier arranged to amplify the signals delivered by said switching means, and a processing means arranged to process the signals outputted by said low noise amplifier(s) either in a first mode or in a second mode, characterized in that it also comprises a control means arranged, when said processing means works in the second mode, to determine which of said first second antennas induces a best reception quality into said processing means, and to set said switching means in the state which allows it to deliver the signals received by the determined antenna.

2. Dual band receiver according to claim 1, characterized in that said control means comprises a triggering means arranged to set the state of said switching means, and an analysis means arranged, when said processing means works in the second mode, i) to order to said triggering means to set said switching means in its first state in order to determine at least a first parameter value representative of the amplitude of the signals outputted by said low noise amplifier(s) consecutively to the setting in the first state, then ii) to order to said triggering means to set said switching means in its second state in order to determine at least a second parameter value representative of the amplitude of the signals outputted by said low noise amplifier(s) consecutively to the setting in this second state, then iii) to compare at least said first parameter value with said second parameter value in order to determine the smallest one, and then iv) to order to said triggering means to set said switching means in the state which induces the smallest of said first and second parameter values.

3. Dual band receiver according to claim 1, characterized in that said control means comprises a triggering means arranged to set the state of said switching means, and an analysis means arranged, when said processing means works in the second mode, i) to order to said triggering means to set said switching means in its second state in order to determine at least a first parameter value representative of the amplitude of the signals outputted by said low noise amplifier(s) consecutively to the setting in this second state, then ii) to order to said triggering means to set said switching means in its first state in order to determine at least a second parameter value representative of the amplitude of the signals outputted by said low noise amplifier(s) consecutively to the setting in this first state, then iii) to compare said first parameter value with said second parameter value in order to determine the smallest one, and then iv) to order to said triggering means to set said switching means in the state which induces the smallest of said first and second parameter values.

4. Dual band receiver according to claim 1, characterized in that said parameter value is the amplitude of the signals outputted by said low noise amplifier(s).

5. Dual band receiver according to claim 1, characterized in that said processing means comprises at least one calculation means arranged to compute at least a parameter value representative of the reception quality, and in that said control means comprises a triggering means arranged to set the state of said switching means, and an analysis means arranged, when said processing means receives second signals and works in the second mode, i) to determine at least the current parameter value computed by said calculation means, then ii) to compare said current parameter value with a chosen threshold, and iii) to order to said triggering means to set said switching means in said first state when said current parameter value is smaller than said threshold.

6. Dual band receiver according to claim 5, characterized in that said calculation means is a radiofrequency automatic gain controller arranged to compute a gain control value defining said parameter value and intended to be used by said processing means.

7. Dual band receiver according to claim 1, characterized in that said processing means comprises at least one first calculation means arranged to compute at least a primary parameter value representative of the reception quality, and in that said control means comprises a triggering means arranged to set the state of said switching means, and an analysis means arranged, when said processing means works in the second mode, i) to order to said triggering means to set said switching means in its first state in order to determine at least a first primary parameter value computed by said first calculation means and a first secondary parameter value also representative of the reception quality, consecutively to the setting in the first state, then ii) to order to said triggering means to set said switching means in its second state in order to determine at least a second primary parameter value computed by said calculation means and a second secondary parameter value also representative of the reception quality, consecutively to the setting in the second state, and then iii) either to stop to intervene if the second secondary parameter value is equal to a chosen value or, if said second secondary parameter value is different from said chosen value, to compare said second primary parameter value with a chosen threshold and either to stop to intervene if the second primary parameter value is greater than said threshold, or to order to said triggering means to set said switching means in its first state if said second primary parameter value is smaller than said threshold and if said first secondary parameter value is equal to said chosen value.

8. Dual band receiver according to claim 7, characterized in that said first calculation means is a radiofrequency automatic gain controller arranged to compute a gain control value defining said primary parameter value and intended to be used by said processing means.

9. Dual band receiver according to claim 7, characterized in that said secondary parameter value is a value of a parameter called “Uncorrectable Packet Count”.

10. Dual band receiver according to claim 1, characterized in that it comprises cascaded first and second low noise amplifiers.

11. Equipment, characterized in that it comprises a dual band receiver according to claim 1.

12. Equipment according to claim 11, characterized in that it is chosen in a group comprising a mobile telephone, a laptop, a personal digital assistant, a portable media player and a television set intended for equipping a vehicle.
